(19) United States
(12) Patent Application Publication
(10) Pub. No.: US 2014/0149913 A1
(43) Pub. Date: May 29, 2014

(54) ELECTRONIC CALENDAR APPLICATION

(71) Applicants: Alain Gauthier, Montreal (CA); Mohannad El-Jayousi, L'lle-Bizard (CA); Rolan Abdukalykov, Montreal (CA); Roy Ghorayeb, Montreal (CA); Vincent Lavoie, Montreal (CA); Xuebo Liang, Brossard (CA)

(72) Inventors: Alain Gauthier, Montreal (CA); Mohannad El-Jayousi, L'lle-Bizard (CA); Rolan Abdukalykov, Montreal (CA); Roy Ghorayeb, Montreal (CA); Vincent Lavoie, Montreal (CA); Xuebo Liang, Brossard (CA)

(21) Appl. No.: 13/685,069

(22) Filed: Nov. 26, 2012

(51) Int. Cl. G06F 3/0481

(52) U.S. Cl. CPC G06F 3/04817
USPC 715/772

(57) ABSTRACT

A portable electronic device including a calendar application having a personalized background media, a touch screen operable to display a calendar entry and to display varying timescales, wherein the calendar application determines one or more recommended background media based on analysis of the calendar entry or timescale, and changes the personalized background media of the calendar application to one of the recommended images.

### BACKGROUND

The present invention relates to electronic calendar applications, and more particularly, to mobile electronic calendar applications that personalize background media of a calendar.

Advances in computing technologies have enabled smaller devices, such as mobile phones and tablets, to execute more sophisticated applications. As a result, users are able to perform many of the functions on their mobile phones and tablets that they previously performed on their personal computers and laptops. For example, users are now able to view websites, e-mail, and calendars on their mobile phones and tablets.

A drawback of smaller devices is their reduced display size. In order to maximize the display size of these smaller devices, touch screen interfaces are often used. The use of a touch screen eliminates the need for a separate keypad such that additional space can be dedicated to a display. Although touch screens help to maximize display size on mobile phones and tablets, their small displays still present challenges to application developers.

For example, calendar entries may include dense amounts of information. Such information is easier to view and comprehend when viewed on the larger screen sizes that are typically found on desktop monitors and laptops. The much smaller screens on mobile phones and tablets make it difficult for a user to quickly find, navigate, and comprehend the dense information that may be included in some calendar applications.

In addition, existing calendar applications are passive applications that display entries in time. Moreover, existing calendar applications do not have customizable or dynamic backgrounds. For example, some calendars, such as theme calendars, have a static side image. Other calendars allow the user to select a calendar image, but after its selection it will become a static image.

Thus, there is a need for a calendar application that quickly illustrates calendar information by dynamically assigning the background of the calendar based on the calendar content and/or timescale (i.e., hour, day, week, month, and year).

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates a method for dynamically assigning background media to a calendar based on the calendar content and/or timescale according to an example embodiment of the present invention.

FIG. 2 illustrates a representative view of a portable electronic device having a calendar application according to an example embodiment of the present invention.

FIG. 3 illustrates another representative view of a portable electronic device having a calendar application according to an example embodiment of the present invention.

FIG. 4 illustrates a representative architecture of a portable electronic device according to an example embodiment of the present invention.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of user interfaces and associated methods for using a device are described. In some embodiments, the device is a portable communication device (e.g., a mobile phone or tablet). The user interface may include a touch screen and/or other input/output devices. In the discussion that follows, a portable communications device is used as an example embodiment. It should be understood, however, that the user interfaces and associated methods may be applied to other devices, such as personal computers and laptops, that may include one or more other physical user-interface devices, such as a keyboard and or mouse.

The portable communication device may support a variety of applications, such as telephone, text messenger, and calendar applications. The various applications that may be executed on the device may use at least one common physical user-interface device, such as a touch screen. One or more functions of the touch screen as well as corresponding information displayed on the device may be adjusted and/or varied from one application to another and/or within a respective application. In this way, a common physical architecture of the device may support a variety of applications with user interfaces that are intuitive and transparent. In the discussion that follows, a calendar application is used as an exemplary embodiment, but it should be understood that the user interfaces and associated methods may be applied to other applications.

A calendar application that personalizes a background media of a calendar application is provided. The background media may be automatically selected based on calendar entries and/or timescale (i.e., hour, day, week, month, and year). Accordingly, the calendar application provides a meaningful media with, for example, a background for multiple business or personal contexts.

The calendar application may automatically select the background media to personalize the calendar. For example, in a personal context, a background media may include images representing a season of the year for a three-month timescale (e.g., summer) or a birthday background media when it is his or her child's birthday. In a business context, a background media may include a meeting image when a user has a meeting scheduled. The background media may also include a graph depicting sales of best selling products for a specific period of time. The background media may also include other images such as graphs, charts, colors, logos, videos, etc.

In addition, the background media may vary according to business entity, time, user, location, etc. A user may select that the background media change dynamically, or may select to manually change the background media at any time.

A user viewing calendar content may vary the timescale. As the timescale changes, the background media may also change. Using the user-interface of the portable communication device, a user may change the timescale. In the case of a touch screen, the timescale may be changed according to a change of a distance separating two user selected points on the screen as at least one of the user selected points is moved by the user. As the user zooms into and out of the timeline, a timescale that is displayed as part of the timeline may also be updated. For example, if a user zooms into a particular timescale showing several years worth of data in the timeline, the timescale may be updated to show fiscal quarters or calendar months instead of years. The entries that are shown in the timeline may also be updated so that they correspond to the selected zoomed in time period. As the entries are updated, the background media may be updated as well. A user using a touch screen device may use at least two of their fingers to select and/or move the two points on the touch screen.

In some instances, detailed information may be displayed for calendar entries when a user zooms into the timeline whereas aggregated, consolidated, or more general information may be displayed when the user zooms out of the timeline. In some instance, the degree of zooming may depend on the separation distance between the two user selected points as the user moves one of the points. As the separation distance changes, the calendar may be further zoomed into making it possible to zoom from displaying several years, to displaying only a few months, to only a few days, and so on by either spreading the two points further apart or moving them closer together. The reverse zoom may also be applied if the points are moved in the opposite direction by either moving them closer together or spreading them apart.

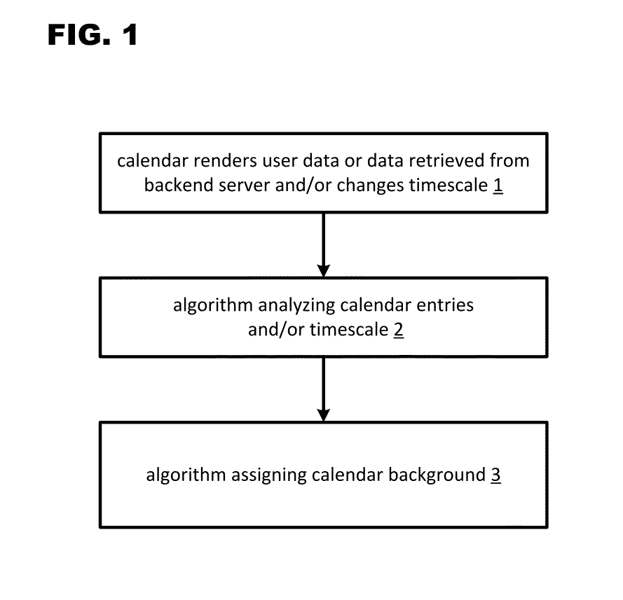

FIG. 1 illustrates a method for dynamically assigning a background media to a calendar based on the calendar content and/or timescale according to an example embodiment of the present invention.

At step 1, the calendar application renders user data and/or data retrieved from backend server and/or changes timescale. The method for personalizing the background media of a calendar can be triggered by the modification of calendar entries and/or timescale. Here, a user opens the calendar application and modifies (adds, deletes, changes, etc.) one or more calendar entries of the electronic calendar. Alternatively, a user may vary the timescale illustrated by the calendar application. In yet another alternative, a change to the background media can be based on information supplied by a backend server.

Initially, the calendar application may require that a user provide a login name and login password to access the calendar. The login name and login password may then be used to identify individual users associated with a calendar.

At step 2, a background algorithm of the calendar application analyzes calendar entries and/or timescale. Here, the background algorithm categorizes calendar entries. For example, the background algorithm identifies personal entries, such as birthdays, anniversaries, and events, as well as business entries, such as budget spending, marketing campaigns, sales orders, customer support tickets, meetings, conference calls, and work function.

The calendar application can also be connected to a backend server (e.g., CRM, ERP, SRM, BI, BW, HANA, etc.) to provide different user interfaces for maintaining business entities, such as marketing promotions, sales orders, products, business partner relations, financial records, budget spending entries, calls, etc. Accordingly, the calendar application can provide a time oriented user interface (e.g., a calendar application) to visualize these business entities. Therefore, the calendar application's content can be retrieved at runtime from a connected backend system, and a user can also edit/add/delete objects from that calendar interface. For example, after analyzing the calendar entries, a chart can be associated with business entities in the connected backend system. In this example, at runtime, the calendar applications may retrieve from the backend system the business entities as well as the associated charts, and may render the chart as background to the calendar.

Next, at step 3, the system of the present invention provides one or more recommended background media for the calendar application. After analyzing the calendar's entries and timescale, the background algorithm automatically selects one or more recommended background media from a media library, the selection being based on one or more predetermined criterion as described below.

A recommended background media may be selected based on various combinations of several criteria. The recommended background media may vary according to calendar entry, timescale, business entity (i.e., user's company or customer), time, user, location, etc. Also, the calendar application may include a background preference menu that enables a user to establish background preferences. Also, a user may select that the background media change dynamically, or may select to manually change the background media at any time.

For example, a user may prefer to display only personal or business related backgrounds. In another example, a user may also prefer to illustrate predetermined types of events as background media. In this example, a user may select to depict teleconference calls, weather information, or birthdays as backgrounds.

In some instances, detailed information may be displayed for calendar entries when a user views a smaller timescale (e.g., hour or day), whereas aggregated, consolidated, or more general information may be displayed when the user views a larger timescale (e.g., week or month). For shorter timescales, an image representing a day's entries may be shown. By contrast, for longer timescales, an image representing a season or quarter may be depicted.

The background media may also be linked to a graph or chart generated from document, presentation, spreadsheet application, business intelligence warehouse, analytic application, etc. As an example, the background media may include a graph depicting sales of best selling products for a specific period of time. In this example, the background graph may be obtained from an application on the user's device or a remote computer or server.

A library of background media may be provided by the calendar application and/or its corresponding backend system such that media for each category of calendar entry may be displayed. Also, the calendar application may access a user's image and video library. In selecting a background media, the background algorithm may analyze the totality or any portion of a user's image and video library. In addition to including previously downloaded media, additional media may be downloaded over the Internet as needed. In other words, the background algorithm may select a background media from a user's device, or alternatively, may download media from an online multi-purpose internet mail extension (MIME) repository. Once an image is downloaded, it becomes part of the user's image library stored on the user's device. As discussed above, the background media may also include other images such as graphs and graphs stored within other applications and remote servers. In addition, the background media may also include videos, such as tutorial, business related information, advertisement, or any kind of animation.

In the library of background media, filenames or metadata may be used to retrieve an appropriate background media. Background media may contain identifying information, such as metadata, that can be used to describe the content of each media. Metadata may include a brief description such as an image title (e.g., holiday, birthday, meeting, chart, etc.) and any other descriptive attributes.

The background algorithm may also generate multiple recommended background media. In this alternative, a user may optionally be directed to select between the multiple recommended background media.

When a user views the dynamically suggested background media, a user can optionally accept or reject the recommended background media. If a recommended background media is rejected by a user, the background algorithm will no longer provide that particular media as a background media for the type of calendar entry and/or timescale for which it was suggested, but rather will proceed to supply another recommended background media. On the other hand, if the recommended background media is accepted, the background algorithm may again select the image for the type of calendar entry and/or timescale for which it was suggested.

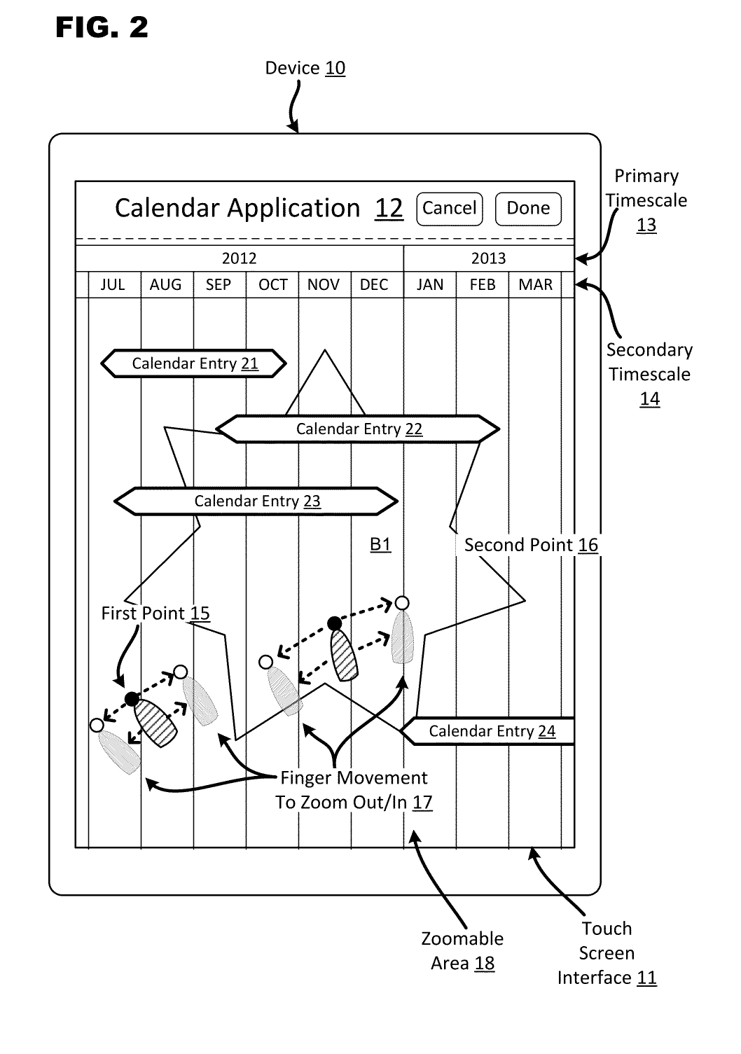

FIG. 2 illustrates a representative view of a portable electronic device having a calendar application according to an example embodiment of the present invention. As shown in FIG. 2, a portable electronic device 10 includes a touch screen interface 11 and calendar application 12 displayed thereon. Within the calendar application 12, a first background media B1 is displayed.

The calendar application 12 may show a horizontal timeline with a primary timescale 13 and a secondary timescale 14. The calendar application 12 may include a zoomable area 18 which may encompass the whole timeline or parts of the timeline where the user may use their fingers 17 or other objects to zoom in or out of the timeline. The calendar application 12 may also display calendar entries 21 to 24 that fall within the time periods displayed within the timeline.

A user may zoom in or out of the timeline by initially selecting first and second points 15 and 16 on the timeline with their fingers or another object. The user may then drag one or more of their fingers to change the distance between the first point 15 and the second point 16. The change in the distance separating the two points may determine whether to zoom in or out of the timeline and by what amount.

As discussed above, a reassessment of the background media is triggered by either a modification of a calendar entry or change in timescale. Here, background B1 may be selected based on calendar entries 21 to 24, changes in timescale, or other user preferences.

Another way to trigger a change of the background media can be to search and filter the objects in the calendar via the filter and search tools that are connected to the corresponding business backend. Therefore, it is possible to search and filter business objects based on a specific set of attributes (status, business partner, customer, type, etc). According to the result of the search, the calendar background media can be adjusted.

In some instances, whenever the timeline is readjusted, the calendar entries and/or other content associated with the timeline may also be reassessed for display in the timeline. In addition to changing the background media, the entries may be resized according to the zoom level and/or a different number of entries may be displayed to make the entries more readable and/or selectable by a user.

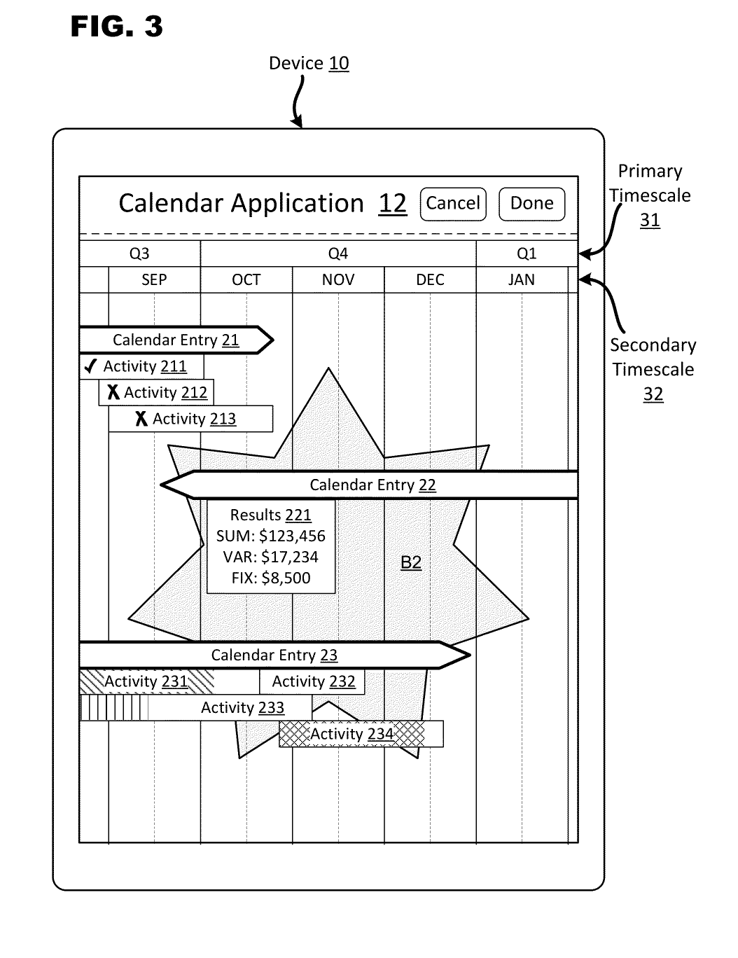

FIG. 3 illustrates another representative view of a portable electronic device having a calendar application according to an example embodiment of the present invention. As compared to FIG. 2, a shorter timeline is depicted in FIG. 3. In other words, FIG. 3 shows a zoomed in view of the calendar application of FIG. 2. As the timescale has changed compared FIG. 2, the background media may also change such that a second background media B2 is displayed.

The zoomed in view may be generated in response to the user dragging at least one of the points in the FIG. 2 to zoom into the timeline. The view of FIG. 2 shows a timeline between July 2012 and March 2013, whereas the zoomed in view in FIG. 3 shows a timeline between September 2012 and January 2013.

When zooming into or out of the timeline, a timescale shown in the timeline displayed across a first dimension may be changed based on the adjusted start and end dates of the timeline. For example, in FIG. 2 the primary timescale 13 displays years, whereas the primary timescale 31 in FIG. 3 displays quarters (instead of years).

The timescale shown in the timeline may be a multidimensional timescale including a primary timescale 13 and 31 and a secondary timescale 14 and 32. The secondary timescale 14 and 32 may have a unit of time that is a subset of the primary timescale 13 and 31. When a multidimensional timescale is changed, at least one of the primary timescale 13 and 31 and the secondary timescale 14 and 32 may be changed accordingly. For example, the primary timescale 31 may be fiscal quarters and the secondary timescale 32 may be months. When zooming out of this calendar view, the primary timescale may change from fiscal quarters 31 to years 13, as shown when zooming out of FIG. 3 to return to the view of FIG. 2.

In some instances, the secondary timescale may be changed between different time units, such as from months to quarters. In other instances, the secondary timescale may continue to show the same time unit, such as months 14 and 32, though the space allocated for time unit may be changed, such as the space allocated for each month on the screen being reduced when zooming out from FIG. 3 to FIG. 2 and the space allocated being increased when zooming in from FIG. 2 to FIG. 3.

As discussed above, the background media of calendar application 12 may vary based on the timescale. The background algorithm may utilize either or both of the primary timescale 13 and 31 and the secondary timescale 14 and 32 in selecting a background media.

When zooming into or out of the calendar application 12, the information about one or more of the calendar entries displayed on the screen may also change. For example, in response to a user zooming into the timeline, additional information associated with each calendar entry may be displayed on the screen. This additional information may be displayed for those calendar entries that are within the adjusted start date and the adjusted end date of the timeline. Of course, the second background media B2 may correspond to the additional information displayed.

The additional information that is displayed may include any information about the activities, tasks, or events associated with a respective calendar entry. In some situations, the displayed additional information may include one or more sub-activity completion status bars 211 to 213. These status bars 211 to 213 may list one or more activities associated with a calendar entry 21 and show a status of the activity, for example, with a check mark or cross, so that a user can quickly identify a status of each activity. As the user further zooms into the calendar application 12, further information about each activity may be displayed, such as sub-activities status bars for each sub-activity associated with an activity. In some instances, the sub-activity status bars may be positioned in the calendar application 12 so that they are aligned with a start, end, or other date associated with the activity.

In some situations, the displayed additional information may include business data 221 about a respective calendar entry. The business data 221 may, but need not, be limited to data included between the adjusted start date and the adjusted end date of the timeline as shown in the zoomed in timeline. The business data 221 may include spending amounts, product details, customer data, performance analytics, or any other business details. As the user further zooms into the calendar application 12, further details about the activity and/or the business data 221 may be displayed. In addition, statistical information may be represented in a graphical or chart format that may be used as second background media B2.

In some situations, the displayed additional information may include one or more sub-activity bars 231 to 234. These bars 231 to 234 may be aligned in the calendar application with a start date and an end date of an activity associated with a respective calendar entry 23. A bar (shown in hatching) may show an overall completion amount of each activity. Bars of contingent activities 231 and 232 may be aligned on a same row. As the user further zooms into the calendar application 12, further details about the activity and/or the completion status of the progress bars 231 to 234 may be displayed.

Information displayed on screen may also be consolidated if the user zooms out of the calendar application 12. For example, in response to a user zooming out of the timeline, calendar entry information displayed on screen may be consolidated to display less information on the screen. Displayed information may also be consolidated when a search is performed or filter is applied. In addition, the displayed information may include information stored on the portable electronic device as well as information originating from the backend system.

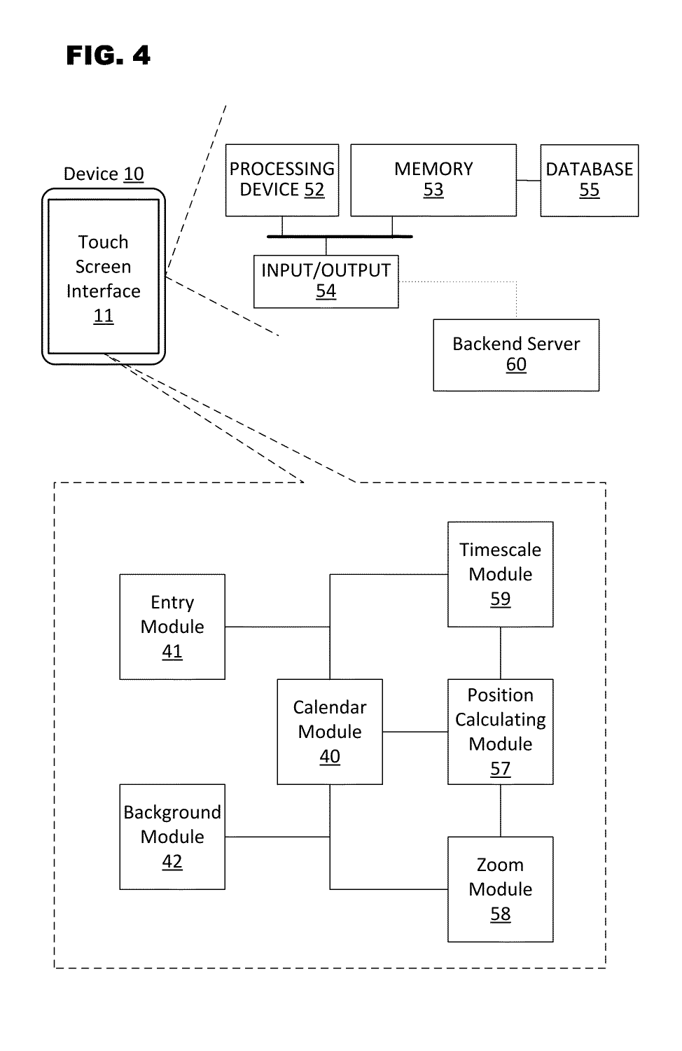

FIG. 4 illustrates a representative architecture of a portable electronic device according to an example embodiment of the present invention.

A portable electronic device 10 may include a touch screen interface 11, processing device 52, memory 53, and communications interface 54. The touch screen interface 11 may include a display, which may be a touch screen, capable of displaying data to a user of the portable electronic device 10.

Although not shown, the touch screen may include a sensor that may be a capacitive touch detection sensor, configured to detect and track movement on the surface and/or in the vicinity of the display. The sensor may be coupled to a signal processing circuit that is configured to identify, locate, and/or track object movement based on the data obtained from sensor.

Portable electronic device 10 may also include a calendar application module 40 that generally implements the functionality of an electronic calendar and manages the connection with the connected backend system that provides the data. Calendar application module 40 may be coupled to other modules including calendar entry module 41, background module 42, position calculating module 57, zoom module 58, and a timescale module 59. Each of the modules may be part of the calendar application, or alternatively, may be part of another application and accessed by the calendar application. For example, the position calculating module 57 is coupled to zoom module 58, both of which may be shared by a variety of applications using the touch screen interface 11.

Memory 53 may include a computer readable medium storing application modules, which may include instructions associated with applications and modules of the portable electronic device 10.

The position calculation module 57 may include functionality for identifying a touched first point and second point within a calendar application displaying a timeline across a first dimension on the touch screen device 10. The position calculation module 57 may also include functionality for calculating a change in a distance between the first point and the second point in response to a dragging of at least one of the touched points, scaling the calculated change in distance with a scaling factor that varies for different units of time in the calendar application, and dividing the scaled calculated change in distance by the width of the displayed timeline and by an adjustment factor to calculate a date change amount.

The zoom module 58 may include functionality for identifying whether the dragging corresponds to a zooming in or a zooming out based on the calculated distance change. The zoom module 58 may also include functionality for adjusting a start date and an end date of the displayed timeline by the calculated date change amount according to whether the dragging is identified as corresponding to the zooming in or the zooming out.

The timescale module 59 may include functionality for changing a timescale shown in the timeline displayed across the first dimension based on the adjusting of the start date and the end date.

As discussed above, the dynamic selection of a background media of a calendar is triggered by the modification of calendar entries, as detected by the calendar entry module 41, and/or changes in timescale, as detected by the timescale module 59. After analyzing the calendar's entries and timescale, the background algorithm of the background module 42 selects one or more recommended background media from a media library stored in memory 53, the selection being based on one or more predetermined criterion as described above in connection with FIG. 1. Alternatively, additional media/images may be downloaded from a network or Internet via communication device 54.

The device 10 may contain a processing device 52, memory 53, and a communications device 54, all of which may be interconnected via a system bus. In various embodiments, the device 10 may have an architecture with modular hardware and/or software systems that include additional and/or different systems communicating through one or more networks via communications device 54.

Communications device 54 may enable connectivity between the processing devices 52 in the device 10 and other systems by encoding data to be sent from the processing device 52 to another system over a network and decoding data received from another system over the network for the processing device 52. Communications 54 device can also connect to backend server 60. As described above, backend server 60 can supply calendar content via a network to device 10.

In an embodiment, memory 53 may contain different components for retrieving, presenting, changing, and saving data and may include computer readable media. Memory 53 may include a variety of memory devices, for example, Dynamic Random Access Memory (DRAM), Static RAM (SRAM), flash memory, cache memory, and other memory devices. Additionally, for example, memory 53 and processing device(s) 52 may be distributed across several different computers that collectively comprise a system. Memory 53 may be capable of storing each user selected value from the displayed second list each time the second list is displayed.

Memory 53 may be connected to database 55 that can be used to store background media and related data, such as metadata. In addition, a cache in memory 53 may store calculated changes to the distance between the first point and the second point during the dragging of at least one of the points. The zoom module 58 may then adjust the start date and the end date of the calendar application only after a stored calculated change in the cache exceeds a threshold value.

Processing device 52 may perform computation and control functions of a system and comprises a suitable central processing unit (CPU). Processing device 52 may include a single integrated circuit, such as a microprocessing device, or may include any suitable number of integrated circuit devices and/or circuit boards working in cooperation to accomplish the functions of a processing device. Processing device 52 may execute computer programs, such as object-oriented computer programs, within memory 53.

The foregoing description has been presented for purposes of illustration and description. It is not exhaustive and does not limit embodiments of the invention to the precise forms disclosed. For example, although the processing device 52 is shown as separate from the modules 57 to 59 and the touch screen interface 11, in some instances the processing device 52 and the touch screen interface 11 and/or one or more of the modules 57 to 59 may be functionally integrated to perform their respective functions.

It will be apparent to those skilled in the art that various modifications and variations can be made in the dynamic calendar of the present invention without departing from the spirit or scope of the invention. Thus, it is intended that the present invention cover the modifications and variations of this invention provided they come within the scope of the appended claims and their equivalents.

We claim:

1. A method for providing a background media for a timeline or calendar application, the method comprising:
analyzing a timeline entry or timescale associated with the timeline;
determining one or more recommended background media based on analysis of the timeline entry or timescale; and
selecting and displaying the determined background media from among the one or more recommended media.

2. The method according to claim 1, wherein the step of analyzing is triggered by rendering at least one timeline entry based on a user action.

3. The method according to claim 1, wherein the one or more recommended background media is supplied by a backend server.

4. The method according to claim 1, wherein the one or more recommended background media is selected from an image storage library that includes a plurality of background media corresponding to a plurality of timeline entry types.

5. The method according to claim 1, wherein the determined background media is a graph derived from statistical information contained in one or more timeline entries.

6. The method according to claim 1, wherein the determined background media is obtained from a non-timeline application linked to the timeline application.

7. The method according to claim 1, wherein a first determined background media is provided for a first timescale and a second determined background media is provided for a second timescale.

8. The method according to claim 1, further comprising the step of prompting a user to optionally accept or reject the determined background media.

9. The method according to claim 8, wherein if the user rejects the determined background media, the image selected as the determined background media is no longer used for similar timeline entries or timescale.

10. The method according to claim 1, wherein the determined background media is displayed on a portable electronic device.

11. A portable electronic device comprising:
a timeline application having a personalized background media;
a touch screen operable to display a timeline entry and to display varying timescales;
wherein the timeline application is to determine one or more recommended background media based on analysis of the timeline entry or timescale, and to change the personalized background media of the timeline application to one of the recommended media.

12. The portable electronic device according to claim 11, wherein the timeline application is to analyze one or more timeline entries and timescale in response to rendering at least one timeline entry based on a user action

13. The portable electronic device according to claim 11, wherein the one or more recommended background media is supplied by a backend server.

14. The portable electronic device according to claim 11, wherein the one or more recommended background media is selected from an image storage library that includes a plurality of background media corresponding to a plurality of timeline entry types.

15. The portable electronic device according to claim 11, wherein the personalized background media is obtained from a non-timeline application of the portable electronic device that is linked to the timeline application.

16. The portable electronic device according to claim 11, wherein a first personalized background media is provided for a first timescale and a second personalized background media is provided for a second timescale.

17. The portable electronic device according to claim 11, wherein a user is optionally prompted to accept or reject the background media.

18. The portable electronic device according to claim 17, wherein if the user rejects the personalized background media, the image selected as the personalized background media is no longer used for similar timeline entries or timescale.

19. A computer readable medium for providing a background media for a calendar application, the computer readable medium:
analyzing a calendar entry or timescale associated with the calendar application;
determining one or more recommended background media based on analysis of the calendar entry or timescale; and
selecting and displaying the determined background media from among the one or more the recommended images.

20. A method for providing a background media for a timeline or calendar application, the method comprising:
analyzing a timeline entry or timescale associated with the timeline, wherein the analyzing is triggered by rendering at least one timeline entry based on a user action;
determining one or more recommended background media based on analysis of the timeline entry or timescale; and
selecting and displaying the determined background media from among the one or more the recommended media, wherein a first determined background media is provided for a first timescale and a second determined background media is provided for a second timescale.
